(19) United States
(12) Patent Application Publication
(10) Pub. No.: US 2011/0070518 A1
(43) Pub. Date: Mar. 24, 2011

(54) UNIT CELL OF SOLID OXIDE FUEL CELL AND STACK USING THE SAME

(75) Inventors: Tae-Ho Kwon, Suwon-si (KR); Sang-Jun Kong, Suwon-si (KR); Duk-Hyoung Yoon, Suwon-si (KR)

(73) Assignee: SAMSUNG SDI CO., LTD., Suwon-si (KR)

(21) Appl. No.: 12/720,512

(22) Filed: Mar. 9, 2010

(30) Foreign Application Priority Data
Sep. 18, 2009 (KR) 10-2009-0088522

(51) Int. Cl. H01M 8/10; H01M 8/24

(52) U.S. Cl. 429/465; 429/482

(57) ABSTRACT

A unit cell of a solid oxide fuel cell (“SOFC”) and a fuel cell stack including the SOFC are disclosed. The SOFC may include a first electrode formed in a hollow cylinder shape, a second electrode formed on an outer surface of the first electrode, an electrolyte layer formed between the first electrode and the second electrode and a cap coupled to an end portion of the first electrode. A seating groove may be formed in the cap such that a conductor may be inserted into the seating groove and be in surface contact with the cap. The cap may include a conductive material and a current collection area of the unit cell may be broad when the fuel cell is included in, a fuel cell stack.

### CROSS-REFERENCE TO RELATED APPLICATIONS

This application claims priority to and the benefit of Korean Patent Application No. 10-2009-0088522, filed on Sep. 18, 2009, in the Korean Intellectual Property Office, the entire content of which is incorporated herein by reference.

### FIELD OF THE INVENTION

An aspect of the present invention relates to a unit cell of a solid oxide fuel cell and a stack using the same, and more particularly, to a unit cell of a solid oxide fuel cell, which can extend the current collection area of the unit cell when it collects current, and a stack using the same.

### DESCRIPTION OF THE RELATED ART

Fuel cells are a high-efficiency, clean generation technology for directly converting hydrogen and oxygen into electric energy through an electrochemical reaction. Generally, the hydrogen is provided from a hydrocarbon-based material such as natural gas, coal gas or methanol, and the oxygen is provided from the air. Such fuel cells are classified as an alkaline fuel cell (“AFC”), a phosphoric acid fuel cell (“PAFC”), a molten carbonate fuel cell (“MCFC”), a solid oxide fuel cell (“SOFC”) or a polymer electrolyte membrane fuel cell (“PEMFC”), depending on the kind of an electrolyte used.

In a fuel cell, electricity, heat and water are generated; an electrochemical reaction is performed as the inverse reaction of electrolysis of water by supplying oxygen to a cathode and supplying hydrogen to an anode. As a result, the fuel cell produces electric energy at a high efficiency without causing pollution.

In general, the PAFC, MCFC and SOFC are referred to as first-, second- and third-generation fuel cells, respectively. The PAFC is a fuel cell using a fuel and a phosphoric acid electrolyte. The fuel includes hydrogen gas containing hydrogen as a main element and oxygen in the air. The MCFC is a fuel cell operated at about 650° C. by using a molten salt as an electrolyte. The SOFC is a fuel cell operated at the highest temperature to generate electricity at the highest efficiency among these fuel cells.

Since the respective fuel cells have various output ranges and uses, an appropriate fuel cell can be selected depending on a purpose. Among these fuel cells, the SOFC has various advantages. For example, in the SOFC it is relatively easy to control the position of an electrolyte, there is no risk of exhaustion of electrolyte because of the fixed position of the electrolyte, and further, the lifespan of a material is long because of it is not very corrosive. Hence, the SOFC has come into the spotlight as a fuel cell for distributed generation, commercial use or domestic use. Further, since the SOFC is a fuel cell operated at a high temperature of about 600° C. to 1000° C. Hence, the SOFC has the highest efficiency and the lowest pollution among various types of fuel cells. Finally, in the SOFC, a fuel reformer is not necessary, and combined power generation is possible.

Meanwhile, since the SOFC cannot obtain a sufficient voltage using only a unit cell, unit cells are connected in stack form. The SOFC may be a tube type or a flat plate type. As between those types, the tube type is estimated that the power density of a stack is lower to a certain degree than that of a stack in the flat plate type but the entire power density of a system is similar to that of a system in the flat plate type. The tube type is an advanced technique for manufacturing large-area fuel cells because unit cells constituting a stack are easily sealed, resistance for thermal stress is strong, and the mechanical strength of the stack is high. Thus, studies on the tube type have been actively conducted.

Tube-type SOFCs may have two types of fuel cells: a cathode supported fuel cell using a cathode as a support and an anode supported fuel cell using an anode as a support. As between them, the anode supported fuel cell is an advanced type, and anode supported fuel cells are being developed as current SOFCs.

The tube-type SOFC is a tubular structure having various sectional shapes such as a cylinder shape and a flat plate shape, in which an electrolyte layer and a cathode are sequentially stacked on an outer surface of an anode supported tube. A fuel gas is necessarily supplied to both ends of a cylinder-shaped or flat-plate-shaped unit fuel cell configured as described above through an inside diameter portion that is a flow path of the fuel gas, for example, a flow path that is inside hollow of an anode while maintaining a sealed state with respect to the exterior of the unit fuel cell. Therefore, conventional caps are formed of glass, glass ceramic or the like and are coupled to both ends of a fuel cell, respectively. However, anode current collection could not be directly performed due to the insulation properties of the caps.

Disclosed in Japanese Patent Laid-Open Publication No. 2002-289249, is a method of collecting current at upper and lower portion of a unit cell using a broad plate. In the method, an SOFC is easily manufactured, but its current collecting efficiency is lowered due to its small area. Disclosed in Korean Patent No. 681007, is a method of collecting current by winding a cathode with a wire formed of silver (Ag). In the method, since a portion at which the wire is in contact with a unit cell is not a plane but a line, current collection is well performed as the winding number of the wire is increased. However, it takes much time to wind the wire for current collection, and the unit cell is not easily connected in series or parallel to other unit cells.

### SUMMARY OF CERTAIN INVENTIVE ASPECTS

In one aspect, there is provided a unit cell of a solid oxide fuel cell (“SOFC”), wherein when collecting current of the unit cell, a seating groove is formed at a cap, and a conductor is inserted into the seating groove to be in surface contact with the cap, so that the current collection area of the unit cell can be broaden, and a stack using the unit cell.

In another aspect, a SOFC includes a first electrode formed in a hollow cylinder shape, a second electrode formed on an outer surface of the first electrode, an electrolyte layer formed between the first electrode and the second electrode and a cap coupled to one end portion of the first electrode. In some embodiments, the cap has at least one seating groove. In some embodiments, a first conductor is inserted in the at least one seating groove and in contact with the cap. In some embodiments, a second conductor electrically connects to the second electrode.

In some embodiments, the second electrode material is formed on the outer circumferential surface except for both end portions of the first electrode. In some embodiments, the cap comprises a conductive material. In some embodiments, the seating groove is formed along the outer circumferential surface of the cap. In some embodiments, the at least one seating groove is formed in the outer circumferential surface of the cap. In some embodiments, the first electrode is an anode, and the second electrode is a cathode.

In another aspect, a stack of an SOFC includes a plurality of unit cells wherein a conductor electrically connects the plurality of unit cells to one another.

In some embodiments, the cap comprises a conductive material. In some embodiments, the seating groove is formed in an outer circumferential surface of the cap. In some embodiments, the first conductor is fixed in the at least one seating groove using a brazing method. In some embodiments, the first conductor is fixed into the at least one seating groove by press fitting the conductor from an upper portion of the conductor using a metal with a greater thermal expansion coefficient than that of the cap. In some embodiments, the first conductor is formed of a material selected from the group including, for example, wire, felt and mesh. In some embodiments, the first electrode is an anode, and the second electrode is a cathode.

In another aspect, a method of forming an SOFC stack includes providing a plurality of unit cells and electrically connecting the plurality of unit cells using a conductor.

In some embodiments the method further comprises forming the at least one seating groove in an outer circumferential surface of the cap. In some embodiments the method further comprises fixing the first conductor in the at least one seating groove using a method selected from the group consisting of brazing and press fitting the conductor from an upper portion of the first conductor using a metal with a greater thermal expansion coefficient than that of the cap. In some embodiments the method further comprises forming the first conductor using wire, felt or mesh.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1 is a perspective view of a unit cell.

FIG. 2A is a perspective view of one side of a cap.

FIG. 2B is a perspective view of the other side of the cap.

FIG. 3 is a sectional view taken along line A-A′ of FIG. 1.

FIG. 4 is a perspective view of a stack using unit cells.

FIG. 5 is a side view illustrating the structure in which unit cells are connected in parallel through a conductor.

FIG. 6 is a side view illustrating the structure in which unit cells are connected in series through a conductor.

FIG. 7 is a perspective view of a cap.

FIG. 8 is a sectional view illustrating the state that a conductor is fixedly inserted into a seating groove.

### DETAILED DESCRIPTION OF CERTAIN INVENTIVE EMBODIMENTS

In the following detailed description, only certain exemplary embodiments have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements. Certain embodiments will be described in more detail with reference to the accompanying drawings, so that a person having ordinary skill in the art can readily make and use aspects of the present disclosure.

Fuel cells according to embodiments of the present disclosure may have various sectional shapes. Therefore, a fuel cell having a cylindrical shape as a representative shape will be described herein below.

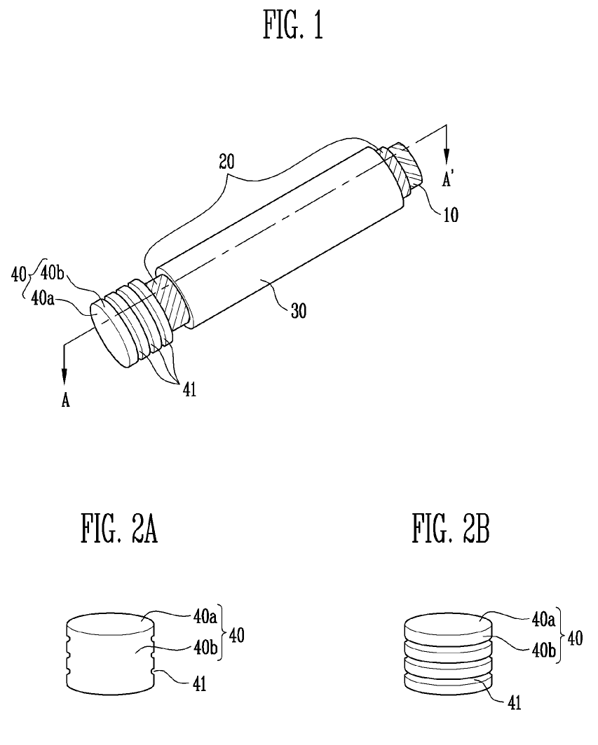

FIG. 1 is a perspective view of a unit cell according to an embodiment of the present disclosure. Referring to FIG. 1, the unit cell of a solid oxide fuel cell (“SOFC”) includes a first electrode 10; a second electrode 30 formed on an outer circumferential surface of the first electrode 10; an electrolyte layer 20 interposed between the first and second electrodes 10 and 30; and a cap 40 connected to one end portion of the first electrode 10. Here, the first and second electrodes 10 and 30 may be an anode and a cathode, respectively.

The anode 10 is formed in the shape of a hollow tube with a cylindrical section, and the cathode 30 is formed on the outer circumferential surface except for both end portions of the anode 10. The electrolyte layer 20 is formed between the anode 10 and the cathode 30. In other words, the unit cell has a structure in which the cathode 30 that is an outermost layer is not formed at both end portions of the anode 10. That is, both end portions of the unit cell are formed into a double stack structure in which the electrolyte layer 20 is coated on the outer circumferential surface of the anode 10 or a structure in which only the anode 10 exists.

For example, LaSrMnO₃ (“LSM”) may be used as an electrode material for the cathode 30, and Ni/YSZ (“cermet”) may be used as an electrode material for the anode 10. Here, yttria stabilized zirconia (“YSZ”) is formed by doping zirconia with yttria (Y₂O₃). Zirconia (ZrO₂) or YSZ may be used as a material of the electrolyte layer 20.

The cap 40 coupled to one end portion of the anode 10 is formed of a conductive material. Since the cap 40 is coupled to the one end portion of the anode 10, one front end portion of the cap 40 is opened so that the anode 10 can be inserted into the cap 40, and the other front end portion of the cap 40 is closed and has an internal space to surround the outer circumferential surface of one end portion of the anode 10. For example, the cap 40 is formed with a circular outer circumferential surface 40b having a constant thickness and an upper end surface 40a perpendicular to the outer circumferential surface 40b. If the cap 40 is in contact with the cathode 30 when it is coupled to the one end portion of the anode 10, a short circuit occurs between the cap 40 and the cathode 30. Therefore, the cap 40 may be coupled to the one end portion of the anode 10 so as not to be in contact with the cathode 30.

Since the cap 40 is formed of a conductive material as described above, the cap 40 is not electrically connected to the cathode 30 while being electrically connected to the anode 10. Therefore, the cap 40 and the cathode 30 become negative (−) and positive (+) electrodes, respectively.

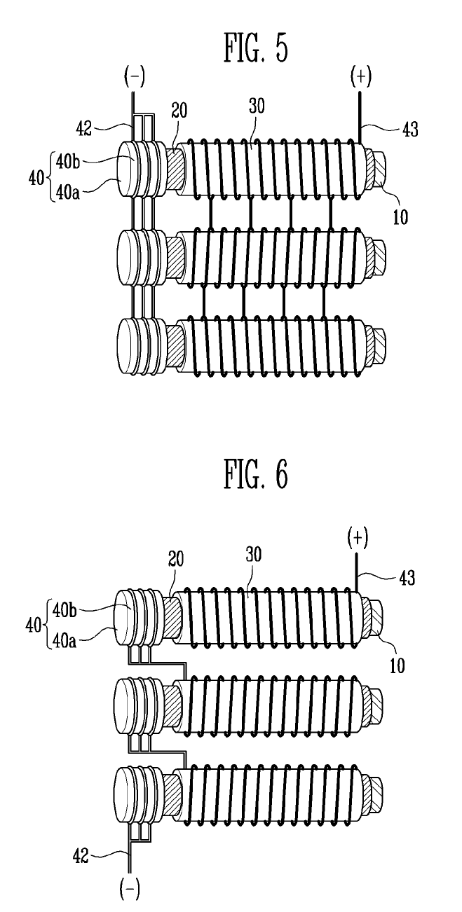

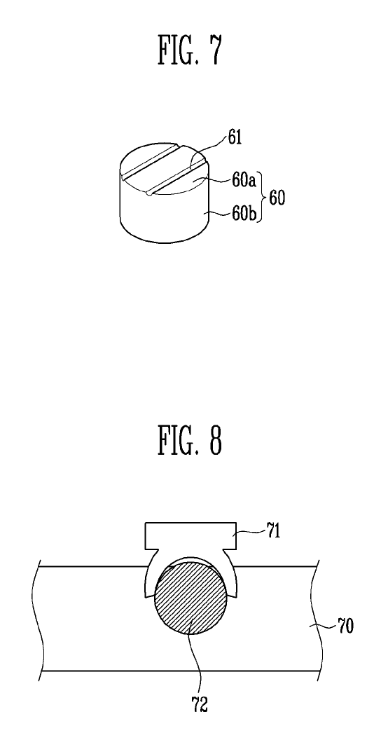

At least one seating groove 41 is formed at the outer circumferential surface of the cap 40. The seating groove 41 is a space into which a conductor 42 (see FIGS. 5 and 6) is inserted so as to be in surface contact with the cap 40. Here, the conductor 42 is connected between adjacent unit cells so that current is moved through the conductor 42 when a stack is manufactured by using unit cells. The sectional shape of the seating groove 41 may be changed depending on the shape of the conductor 42 inserted into the seating groove 41.

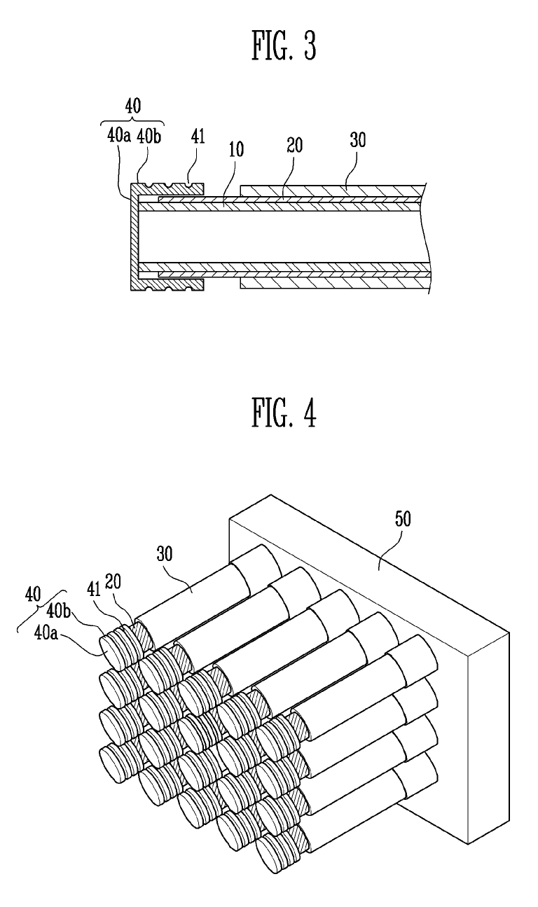

FIG. 2A is a perspective view of one side of a cap according to an embodiment of the present disclosure. FIG. 2B is a perspective view of the other side of the cap according to the embodiment of FIG. 2A. Referring to FIGS. 2A and 2B, the seating groove 41 having a semi-circular sectional shape is formed along the outer circumferential surface 40b of the cap 40. The seating groove 41 may be formed at the entire outer circumferential surface 40b of the cap 40 but may be formed only a portion of the outer circumferential surface 40b, viewed from one side as shown in FIGS. 2A and 2B. When connecting between adjacent unit cells, the conductor 42 is wound spirally around the cap 40 but is inserted into the seating groove 41 formed at one side of the cap 40 so as to be in surface contact with the cap 40. Accordingly, the manufacturing time of a stack can be reduced, and unit cells can be easily connected. The conductor 42 inserted into the seating groove 41 will be described in detail with reference to FIGS. 5 and 6.

FIG. 3 is a sectional view taken along line A-A′ of the embodiment illustrated in FIG. 1. Referring to FIG. 3, as described above, the unit cell includes a tube-shaped hollow anode 10; a cathode 30 formed on the outer circumferential surface except for both end portions of the anode 10; and an electrolyte layer 20 formed between the anode 10 and the cathode 30. A cap 40 is connected to one end portion of the anode 10. Here, the electrolyte layer 20 is not formed at both end portions of the anode 10. However, it will be apparent that the electrolyte layer 20 may be formed up to both end portions of the anode 10 because of its insulation property.

The cap 40 is provided with an outer circumferential surface 40b and an upper end surface 40a perpendicular to the outer circumferential surface 40b, and at least one seating groove 41 is formed at the outer circumferential surface 40b. The seating groove 41 is a space into which the conductor 42 is inserted so as to be in surface contact with the cap 40.

FIG. 4 is a perspective view of a stack using unit cells according to another embodiment of the present disclosure. Referring to FIG. 4, in the stack, unit cells are regularly arranged, and adjacent unit cells are electrically connected by a conductor 42 (see FIG. 5). Each of the unit cells includes a tube-shaped anode 10, an electrolyte layer 20, a cathode 30 and a conductive cap 40 coupled to one end portion of the anode 10. Here, the conductor may be formed of any one selected from the group consisting of wire, felt and mesh. The felt refers to a porous structure formed by randomly conglomerating a filament like cotton. If adjacent unit cells are connected to maintain an optimal surface contact, a reliable contact may be made by winding felt or a felt pad in the seating groove 41 of the cap 40 and then winding a wire on the felt.

Although a conductor for electrically connecting unit cells is not illustrated in FIG. 4, it may be inserted into the seating groove 41 formed at the outer circumferential surface 40b of the cap 40 so as to be in surface contact with the cap 40. Accordingly, adjacent unit cells can be easily connected without welding or a special instrument, so that current can be moved through the conductor. The inserted form of a conductor and the electrical connection between unit cells will be described in detail with reference to FIGS. 5 and 6. In some embodiments, a manifold 50 may be provided at the other end portion of the anode 10 so that a fuel can be supplied to or discharged out from the unit cells through the manifold 50. Here, the manifold is provided only for illustrative purpose, and another fuel supply means for supplying a fuel to unit cells may also be provided at the other end portion of the anode 10.

FIG. 5 is a side view illustrating the structure in which unit cells are connected in parallel through a conductor according to another embodiment of the present disclosure. FIG. 6 is a side view illustrating the structure in which unit cells are connected in series through a conductor according to another embodiment of the present disclosure. Referring to FIGS. 5 and 6, a cap 40 allows one end portion of each unit cell to be closed to the exterior surroundings, and is coupled to an anode 10 exposed at the one end portion of each of the unit cells. A conductor 42 is inserted into a seating groove 41 formed at one outer circumferential surface 40b of the cap 40 so as to be in surface contact with the cap 40. Because the conductor 42 is inserted into the seating groove 41, the seating groove 41 is obscured in FIGS. 5 and 6. Through such a manner, the anodes 10 of adjacent unit cells can be consecutively connected to one another without welding. A metallic conductor 43 wound spirally along an axis direction of cathodes 30 is formed at an outer circumferential surface of each of the cathodes 30. Here, the brazing method may be used as a method of fixing the conductor 42 to the seating groove 41.

The brazing method refers to a method of combining two objects to be combined with each other. In the brazing method, a filler metal having a lower melting point than those of the two objects is melted by applying heat thereto, and the molten filler metal flows between the two objects by means of a capillary phenomenon. Then, the two objects are combined with each other while the molten filler metal is solidified.

If a region at which a conductor is inserted into a seating groove is heated, a filler metal is melted, and the molten filler metal is filled in a gap between the seating groove and the conductor. Therefore, the molten filler metal is cooled and solidified while being completely filled in the gap between the seating groove and the conductor, so that the seating groove and the conductor can be perfectly sealed. Although a heating method for brazing may include a variety of methods, a high-frequency induction heating method or a vacuum heating method under an inert atmosphere maybe used as the heating method for brazing so as to prevent oxidation of a metal and reduce a heating time.

Referring to FIG. 8, as another method of fixedly inserted a conductor 72 into a seating groove, a side portion of a metal 71 may be fixedly inserted into the seating groove together with the conductor 72 by press-fitting the conductor 72 from an upper portion of the conductor 72 using the metal with a greater thermal expansion coefficient than that of a cap 70. That is, the conductor 72 is fixedly inserted into the seating groove by putting the conductor 72 on a curved surface of the cap 70, positioning the metal 71 on an upper portion of the conductor 72 and then press fitting the metal 71. Here, the metal 71 is manufactured to have a shape enabling the conductor 72 to be fixedly inserted in the seating groove by pressing the metal 71 like a button. Therefore, although the metal 71 is operated at a high temperature, loose portions are tightened or corrected by its thermal expansion coefficient, so that the surface contact between the conductor 72 and the seating groove can be well maintained.

To increase current of a stack having unit cells electrically connected to one another, the number of unit cells having anodes connected in parallel (FIG. 5) by the conductor 42 is necessarily increased. To obtain a high voltage, the number of unit cells connected in series (FIG. 6) by connecting the conductor 42 of the anodes 10 to the conductor 43 spirally wound around the cathodes 30 is necessarily increased.

The hydrogen supplied to the hollow of a cylindrical unit cell is converted into hydrogen ions by providing electrons to an anode 10 serving as a support and an electrode. The electrons provided to the anode 10 move toward a cathode 30 of an adjacent unit cell so as to ionize oxygen molecules. The oxygen ions move toward an adjacent anode 10 through an electrolyte layer 20 and react with hydrogen ions to form water, thereby completing a fuel cell reaction. The stacked unit cells generate electricity and heat while continuously performing the aforementioned reaction.

Three unit cells are illustratively shown in FIGS. 5 and 6. In FIG. 5, the conductor 42 fixedly inserted into a seating groove 41 of one unit cell is connected in parallel to a seating groove 41 of an adjacent unit cell, thereby collecting current. In FIG. 6, the conductor 42 fixedly inserted into a seating groove 41 of one unit cell is connected in series to a seating groove 41 of an adjacent unit cell, thereby collecting current.

As described above, a stack structure having a plurality of unit cells may be completed by connecting a conductor 42 through which seating grooves 41 of adjacent unit cells are connected in parallel to a conductor 43 spirally wound around cathodes 30. Accordingly, the number of unit cells connected in parallel and the number of unit cells connected in series can be appropriately controlled depending on the capacity of a fuel cell.

FIG. 7 is a perspective view of a cap according to another embodiment of the present disclosure. Referring to FIG. 7, a seating groove 61 may be formed while crossing an upper surface 60a perpendicular to an outer circumferential surface 60b of the cap 60. Therefore, when adjacent two unit cells are electrically connected to each other, a conductor inserted into the seating groove 61 can be simply arranged in a straight line, thereby reducing time for electrical connecting between unit cells when manufacturing a stack. Further, a conductor is inserted into the seating groove 61 to be in surface contact with the cap 60, thereby improving a current collection density.

In some embodiments, a unit cell of an anode supported fuel cell, of which first and second electrodes are an anode and a cathode, respectively, has been described as an example. However, it will be apparent that the present disclosure may be applied to a unit cell of a cathode supported fuel cell, of which first and second electrodes are a cathode and an anode, respectively.

While the present invention has been described in connection with certain exemplary embodiments, it will be appreciated by those skilled in the art that various modifications and changes may be made without departing from the scope of the present disclosure. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Thus, while the present disclosure has described certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A unit cell of a solid oxide fuel cell (“SOFC”), comprising:
a first electrode formed in a hollow cylinder shape;
a second electrode formed on an outer surface of the first electrode;
an electrolyte layer formed between the first electrode and the second electrode; and
a cap coupled to one end portion of the first electrode,
wherein the cap has at least one seating groove,
wherein a first conductor is inserted in the at least one seating groove and in contact with the cap, and
wherein a second conductor electrically connects to the second electrode.

2. The unit cell of claim 1, wherein the cap comprises a conductive material.

3. The unit cell of claim 1, wherein the seating groove is formed along the outer circumferential surface of the cap.

4. The unit cell of claim 1, wherein the at least one seating groove is formed in the outer circumferential surface of the cap.

5. The unit cell of claim 1, wherein the first electrode is an anode, and the second electrode is a cathode.

6. A stack of SOFCs, comprising:
a plurality of unit cells of claim 1,
wherein the first conductor electrically connects the plurality of unit cells to one another.

7. The stack of claim 6, wherein the cap comprises a conductive material.

8. The stack of claim 6, wherein the seating groove is formed in an outer circumferential surface of the cap.

9. The stack of claim 6, wherein the first conductor is fixed in the at least one seating groove using a brazing method.

10. The stack of claim 6, wherein the first conductor is fixed into the at least one seating groove by press fitting the conductor from an upper portion of the conductor using a metal with a greater thermal expansion coefficient than that of the cap.

11. The stack of claim 6, wherein the first conductor is formed of a material selected from the group consisting of wire, felt and mesh.

12. The stack of claim 6, wherein the first electrode is an anode, and the second electrode is a cathode.
